(19) United States
(12) Patent Application Publication
(10) Pub. No.: US 2025/0315487 A1
(43) Pub. Date: Oct. 9, 2025

(54) POSITIVE CONTROL OF HIGH VALUE DOCUMENTS

(71) Applicant: VIRGINIA TECH INTELLECTUAL PROPERTIES, INC., Blacksburg, VA (US)

(72) Inventor: Alan J. Michaels, Blacksburg, VA (US)

(21) Appl. No.: 19/169,610

(22) Filed: Apr. 3, 2025

Related U.S. Application Data
(60) Provisional application No. 63/573,991, filed on Apr. 3, 2024.

(51) Int. Cl. G06F 16/93; H04W 4/029

(52) U.S. Cl. CPC G06F 16/93; H04W 4/029

(57) ABSTRACT

Embodiments directed to positive control of physical documents and removeable media devices are described. In one example embodiment, a computer-implemented method for positive control of physical documents includes determining that a document includes content of a defined type. The method further includes generating a physical document based at least in part on the document. The physical document includes the content and a unique identifier. The method further includes tracking the physical document based at least in part on document detection data obtained from at least one peripheral device that detects the unique identifier during a life cycle of the physical document. The document detection data is at least indicative of a status of the physical document at a time of detection by the at least one peripheral device. The method further includes performing one or more operations based at least in part on the document detection data.

### CROSS REFERENCE TO RELATED APPLICATIONS

This application claims the benefit of and priority to U.S. Provisional Application Ser. No. 63/573,991, filed Apr. 3, 2024, and titled “POSITIVE CONTROL OF HIGH VALUE DOCUMENTS,” the entire contents of which are hereby incorporated herein by reference.

### BACKGROUND

Maintaining positive control of physical objects through their life cycles offers a number of advantages across different domains. For example, maintaining positive control of certain types of physical objects can be useful in preventing counterfeiting, insider threats, and cybersecurity attacks. Some existing physical-based positive control systems include unique identifiers that are positioned on or embedded in different types of physical objects. The unique identifiers can be detected using various destructive or non-destructive scanning methods to authenticate or track such objects. Additionally, some existing digital-based positive control systems utilize computing devices and computer-implemented methods to authenticate or track different types of digital objects (e.g., digital files or documents).

### SUMMARY

The present disclosure is directed to systems and methods for positive control of physical objects such as, for instance, individual sheets of printed paper. For example, the embodiments described herein can be implemented to generate a physical document having a unique identifier that can be used to track, record, and manage various events associated with the document over its entire life cycle. For instance, the physical document can be embodied as a single sheet of paper having one or more unique identifier(s) positioned on or embedded in the sheet of paper. The embodiments can interface with and control one or more peripheral devices to track, record, and manage various events associated with the document over its entire life cycle based at least in part on detecting the unique identifier as described in examples herein. In other, similar embodiments, the physical object possessing one or more unique identifying characteristics is any form of removeable media that contains data (e.g., a compact disc) or a physical component used in a security management flow (e.g., a label or tamper-resistant tape).

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, a computing device includes a memory device to store computer-readable instructions thereon and at least one processing device configured through execution of the computer-readable instructions to determine a document comprises content of a defined type. The at least one processing device is further configured to generate a physical document based at least in part on the document. The physical document includes the content and a unique identifier. The at least one processing device is further configured to track the physical document based at least in part on document detection data obtained from at least one peripheral device that detects the unique identifier during a life cycle of the physical document. The document detection data is at least indicative of a status of the physical document at a time of detection by the at least one peripheral device. The at least one processing device is further configured to perform one or more operations based at least in part on the document detection data.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a block diagram of an example environment according to various aspects and embodiments of the present disclosure.

FIG. 2 illustrates a flow diagram of an example computer-implemented method according to various aspects and embodiments of the present disclosure.

FIG. 3 illustrates a flow diagram of another example computer-implemented method to implement an example life cycle of a document or removeable media item according to various aspects and embodiments of the present disclosure.

FIG. 4 illustrates a block diagram of example document or removeable media modifications according to various aspects and embodiments of the present disclosure.

### DETAILED DESCRIPTION

Embodiments of the present disclosure provide a robust method for marking, logging, tracking, and accounting for destruction of physical objects such as high value documents or removeable media in some cases. Such documents may be used in legal exchanges, sensitive business trade secrets, or for government-level data protections, to name a few example applications. One embodiment includes a unique identifier that can be positioned on or embedded in a page of printed text during manufacturing or printing (e.g., with special inks). The embodiments further include a back-end database and tracking system that can be utilized to interface with at least one peripheral device to track and record various events associated with such a page of printed text over its life cycle. For instance, the back-end database and tracking system can be configured to interface with at least one of a printer, shredder, copier, scanner, fax machine, or infrastructure component (e.g., a doorway that scans for documents entering or leaving a facility) to track and record various events associated with the page of printed text over its life cycle.

The ability of the embodiments to maintain positive control of physical objects through their life cycles offers a significant improvement in preventing or mitigating, for instance, counterfeiting, insider threats, and cybersecurity attacks. By implementing “positive control,” the embodiments can build and maintain a chain of custody for a physical item throughout its use in a traditional office environment. One embodiment provides a method to track documents at a page-by-page level from creation (e.g., on a printer or a notepad of marked blank sheets), through modification or dissemination (e.g., via a copier, scanner, fax machine), through its movement entering, within, and exiting a facility (e.g., via a scanner, sensor, intelligent infrastructure device), and ultimately through its destruction (e.g., via a shredder). The embodiments are backed by tracking software that can tie specific users, locations, actions, or events to one or more particular pages of a document or a certain piece of removeable media in many examples, thereby allowing for complete life cycle management and forensics of the physical item. Example applications of the embodiments include the dissemination and management of classified materials, legal transactions, handling of evidence, trusted supply chains, and authenticated merchandise and materials, among others.

Current radio-frequency identification (RFID) approaches exist for currency. However, such RFID approaches fail to provide positive control aspects where an entire lifetime of a document may be recorded, including who accesses, who handles it, when it is handled, and verification that it is destroyed. As a solution to this problem, the embodiments described herein can integrate unique identifiers, supporting “canary trap”-style security mechanisms when multiple parties have access to information in many cases. Some embodiments can be used during the execution of a “trusted” supply chain, with each party adding some type of endorsement at each stage (e.g., using blockchain techniques).

One example application of the embodiments is in connection with the legal profession and industry. For example, the embodiments can be implemented to keep track of contracts, agreements, and other documents, including potential authenticity of the documents. In one example, the embodiments can be configured to detect the creation of an electronic contract, agreement, or other electronic document that becomes a legally binding document once all parties involved have executed the electronic document by way of electronic signatures. In this example, the embodiments can be further configured to operate a document generator device (e.g., an ink printer, an additive manufacturing printer, a three-dimensional (3D) printer) to print an electronically signed version of the electronic document in analog form (e.g., physical form, printed form) such that a resulting physical document includes a unique identifier embedded (e.g., integrated) in or positioned (e.g., formed, printed) on the physical document. The embodiments in this example are further configured to at least interface with or control one or more peripheral devices to track the physical document using the unique identifier and record various events associated with the physical document over its life cycle.

Another example application of the embodiments is in connection with managing various business-related contracts and agreements such as trade secrets in some cases. For example, the embodiments can be implemented to keep track of analog versions (e.g., physical versions, printed versions) of trade secret agreements that can be generated based on electronically executed trade secret agreements and can include unique identifiers as described herein.

Another example application of the embodiments is in connection with government management of controlled documents or removeable media. For example, the embodiments can be implemented to keep track of entire lifecycles of various classified documents, including exchanges of documents between parties, recording histories of where documents have transited, support inventories of those documents, identify if those documents leave physically controlled facilities, determine who has accessed them, and when they were destroyed.

Another example application of the embodiments is in connection with industry. For example, the embodiments can be implemented to integrate scanning and printing capabilities of RFIDs, quantum dots, and/or other unique identifiers into individual pages of a document and into commercial printers, copiers, scanners, and shredders in some cases. For instance, the embodiments can be implemented to integrate scanning and printing capabilities of RFIDs and/or other unique identifiers into individual pages of a document to allow for verification that a document is full length and all pages are accounted for. The embodiments can be implemented to track, record, and manage the entire lifecycle of any or all pages of a document using at least one peripheral device in conjunction with back-end tracking and logging software components.

Another example application of the embodiments is in connection with manual generation of controlled documents such as engineering notebooks in some cases. For example, the embodiments can be implemented via the manufacture of paper that is pre-impregnated with non-visible magnetic ink or quantum dots that serve as unique identifiers for each page. For instance, these unique identifiers can be used to validate the authenticity of an engineering notebook or other handwritten document.

Another example application of the embodiments is in connection with establishing legal chain of custody for a physical item such as evidence in a court case in some examples. For instance, the use of custom inks, quantum dots, or other signature in a tamper evident seal can be used to validate manual handling of physical objects contained within a sealed container.

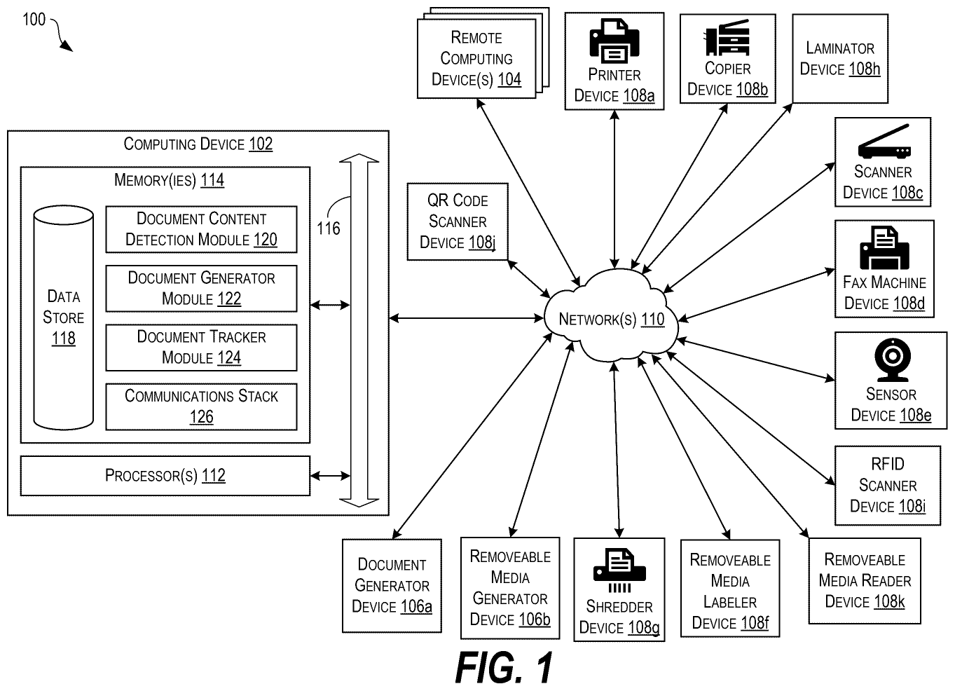

For context, FIG. 1 illustrates a block diagram of an example environment 100 according to various aspects and embodiments of the present disclosure. The environment 100 can be a computing environment in which classical and quantum computing operations, electronic and electrical-based operations, mechanical-based operations, electromechanical-based operations, optical-based operations, magnetic-based operations, electromagnetic-based operations, chemical-based operations, scanning operations, non-destructive and destructive evaluation operations, and data communication operations can be performed, among other operations. The environment 100 is illustrated as a representative example, and the positive control concepts of embodiments described herein are not limited to use with any particular type of computing environment.

The environment 100 includes a computing device 102, one or more remote computing devices 104 (or “remote computing devices 104”), a document generator device 106a, a removeable media generating device 106b, and one or more peripheral devices 108, among other components. In the example shown, the peripheral devices 108 include a printer device 108a, a copier device 108b (e.g., a photocopier), a scanner device 108c, a fax machine device 108d, a sensor device 108e, a removeable media labeler device 108f, a shredder device 108g, a laminator device 108h, an RFID scanner device 108i, a quick response (QR) code scanner device 108j, and a removeable media reader device 108k. In some examples, the environment 100 may include a different number or type of device compared to those shown in FIG. 1. The computing device 102, the remote computing devices 104, the document generator device 106a, the removeable media generating device 106b, and the peripheral devices 108 are coupled to one another by way of one or more networks 110 (or “networks 110”). The document generator device 106a and the removeable media generating device 106b can each be configured to create new physically controlled items that support positive tracking as described in examples herein.

The computing device 102 and any or all of the remote computing devices 104 in many examples can be individually embodied and implemented as at least one of a server computing device, a client computing device, a general-purpose computer, a special-purpose computer, a virtual machine, a supercomputer, a laptop, a tablet, a smartphone, or another type of computing device that can be configured and operable to perform various operations described herein. The computing device 102 and any or all of the remote computing devices 104 can be individually embodied as a server computer or related computing system providing computing capability in some cases. The computing device 102 and any or all of the remote computing devices 104 can each employ a plurality of computing devices arranged in one or more server banks, computer banks, or other arrangement in some examples. Such computing devices may be located in a single installation or may be distributed among many different geographical locations. For example, the computing device 102 and any or all of the remote computing devices 104 can each include a plurality of computing devices implemented as a hosted computing resource, a grid computing resource, and/or any other distributed computing arrangement. In some cases, the computing device 102 and any or all of the remote computing devices 104 can each correspond to an elastic computing resource where the allotted capacity of processing, network, storage, or other computing-related resources may vary over time.

The document generator device 106a can be embodied and implemented at least in part as an analog object printer (e.g., physical object printer, document printer) that can generate a physical document with a unique identifier that is embedded (e.g., integrated) in the physical document or positioned on (e.g., formed on, printed on) a surface of the physical document. In various examples, the document generator device 106a can be embodied and implemented at least in part as one or more of an ink printer, a three-dimensional (3D) printer, an additive manufacturing printer, or another type of printer that can generate physical documents having unique identifiers as described herein.

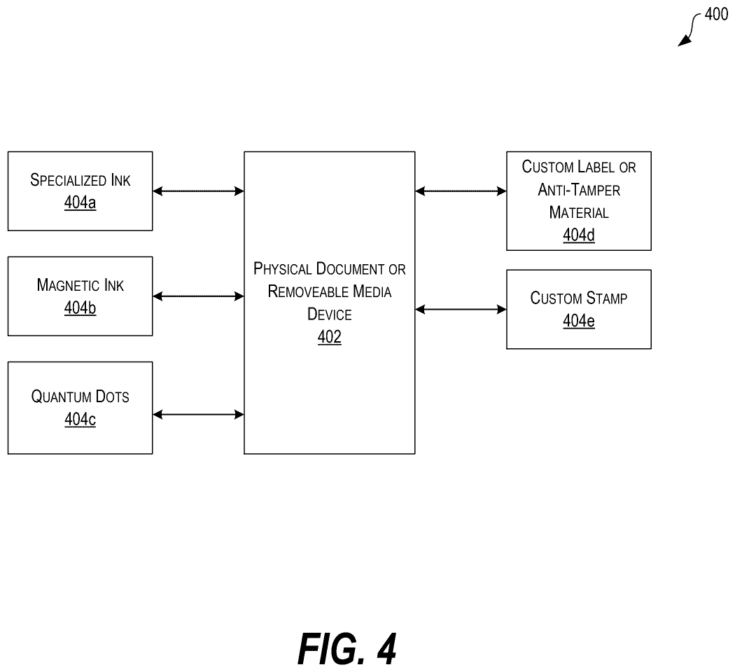

In one example, the document generator device 106a can generate a physical document as at least one of a sheet of material, a film, a sheet of fibers, a sheet of paper, a textile, a sheet of fabric, or a plate having content formed (e.g., via material deposition or etching) as text on a surface of such a document. The document generator device 106a can generate a physical document (e.g., a sheet of paper) such that it includes one or more unique identifiers. Examples of such unique identifiers include, but are not limited to, a watermark identifier, a unique signature identifier, a security signature identifier, an encryption-based identifier, a logo identifier, a two-dimensional (2D) or three-dimensional (3D) barcode, a 2D or 3D quick response (QR) code, a physical property identifier, a chemical identifier, an electrical identifier, an electromagnetic identifier, an optical identifier, a quantum-based identifier (e.g., a quantum dots-based identifier), or another unique identifier. Additional embodiments of a document that can be generated as described in examples herein using the document generator device 106a or the removeable media generating device 106 are described with reference to the block diagram illustrated in FIG. 4.

In another example, the document generator device 106a can generate a physical document (e.g., a sheet of paper) such that it includes a unique identifier formed as at least one of a 2D or 3D unique identifier structure or pattern, a 2D or 3D machine-readable or machine-recognizable identifier structure or pattern, a 2D or 3D barcode structure or pattern, a 2D or 3D quick response code structure or pattern, a watermark structure or pattern, a unique signature structure or pattern, a security signature structure or pattern, an encryption structure or pattern, a logo structure or pattern, or another type of identifier structure or pattern. Each of the machine-readable or recognizable 2D or 3D barcodes and quick response codes that can be formed (e.g., using ink, toner, carbon copy transfer, dot-matrix printer ribbon transfer) in or on a physical document (e.g., a sheet of paper) by the document generator device 106a can be associated with, indicative of, and correspond to various data related to such a document. Examples of such data include, but are not limited to, source data (e.g., document authors, originators, owners, signatories), document identity data (e.g., contract or agreement reference number), user-document rights and privileges data (e.g., identifying users having certain rights and privileges associated with a physical document), document use data (e.g., specifying how a physical document may be used by various users), action or operation data (e.g., specifying certain actions or operations that are to be performed in connection with a physical document based on a detection, use, or attempted use of such a document), security data (e.g., watermark), timestamps, traceability or tracking data, encryption data, other data, or any combination thereof.

In another example, the document generator device 106a can generate a physical document (e.g., a sheet of paper) by depositing ink or toner (e.g., using ink, toner, carbon copy transfer, dot-matrix printer ribbon transfer, quantum dots) on a surface of the document to form content as text on the surface of the document. The document generator device 106a can generate the document such that an addition or ink includes a unique identifier. For instance, the document generator device 106a can generate a physical document (e.g., a sheet of paper) such that ink or toner (e.g., ink, toner, carbon copy transfer, dot-matrix printer ribbon transfer) deposited on a surface of the document to form text includes one or more certain physical, chemical, electrical, electromagnetic, optical, or quantum mechanical properties or effects that form a unique identifier for such a physical document. Similarly, the document generator device 106a may embed an addition or ink into the structure or internal layers of a document.

The removeable media generator device 106b can be embodied and implemented at least in part as one or more manufacturing or semiconductor fabrication devices that can individually or collectively generate a removable media device with a unique identifier that is embedded (e.g., integrated) or otherwise included in the removable media device. Example removable media devices that can be generated with such a unique identifier include, but are not limited to, semiconductor and superconductor devices, universal serial bus (USB) flash drives, memory cards, optical discs (e.g., compact discs (CD) or digital versatile discs (DVD)), floppy disks, and magnetic tapes. In one example, the removeable media generator device 106b can generate a removeable media device (e.g., a compact disc) that is impregnated with a detectable additive (e.g., using ink, toner, carbon copy transfer, dot-matrix printer ribbon transfer, quantum dots) or has the equivalent additive printed on its surface. For instance, the removeable media generator device 106b can integrate such a detectable additive into a substrate included in a removeable media device or form the detectable additive on a surface of the substrate.

Any or all of the peripheral devices 108 can be embodied and implemented at least in part as an intelligent device in many examples. For instance, any or all of the peripheral devices 108 can be embodied and implemented as an Internet-of-Things (IoT) device that can include or be coupled to a computing and data communication device such as a computer (e.g., a processor and a memory having instructions executed by the processor). Each of the peripheral devices 108 can include or be coupled to at least one of a sensor, a scanner (e.g., an optical, electrical, chemical, or electromagnetic scanner), a camera, a microphone, or another non-destructive evaluation (NDE) system that can detect at least one of a physical document, a unique identifier included in or on the physical document, or content of text printed on the physical document. Additionally, each of the peripheral devices 108 can be configured to perform their respective operations.

In various examples, the peripheral devices 108 can be configured to perform at least their following respective operations. The printer device 108a can print ink on an individual sheet of paper to create a physical document. The copier device 108b can create a copy of a physical document on an individual sheet of paper. The scanner device 108c can generate, transmit, and render a scanned image (e.g., a digital image) of a physical document. The fax machine device 108d can create, transmit, and render a fax image (e.g., a fixed graphic image) of a physical document. The sensor device 108e can detect or capture images (e.g., static images, video) of a physical document, a unique identifier included in or on the physical document, or content of text printed in or on the physical document. The removeable media labeler device 108f can affix a marked label in or on a physical document. The shredder device 108g can shred a physical document into a multitude of relatively thin sections or strips. The laminator device 108h can embed one or more layers of additive signatures encased in or on a physical document. The RFID scanner device 108i can use electromagnetic signal(s) to excite an embedded signature to a document or object when placed in contact or transmitted at a distance. The QR code scanner device 108j can use optical reading and computing capabilities to uniquely identify a document with an embedded signature. The removeable media reader device 108k supports scanning of removeable media devices such as deciphering impregnated quantum dots on a compact disc.

In some examples, at least one of the sensor device 108e or the RF scanning device 108i can be embodied and implemented as an infrastructure component or device such as an intelligent infrastructure component or device. For instance, at least one of the sensor device 108e or the RFID scanner device 108i can be embodied such that the device is included in or coupled to a computing device and an infrastructure component such as a door frame, a door, a wall, or a ceiling, among other infrastructure components. At least two of the peripheral devices 108 can be embodied together in a single unit or system in one example. For instance, at least two of the printer device 108a, the copier device 108b, the scanner device 108c, and the fax machine device 108d can be embodied together in a single unit or system. In another example, the sensor device 108e and the RFID scanner device 108i can be embodied together in a single unit or system. The RFID scanner device 108i can be embodied and implemented as an electromagnetic field (EMF) scanner device that can detect an electromagnetic field or certain material in some examples rather than a specific signal.

The networks 110 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The computing device 102, the remote computing devices 104, the document generator device 106a, the removeable media generator device 106b, and the peripheral devices 108 can communicate data with one another over the networks 110 using any suitable systems interconnect models and/or protocols. Example interconnect models and protocols include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the networks 110, without limitation. Although not illustrated, the networks 110 can also include connections to any number of other network hosts, such as website servers, file servers, networked computing resources, databases, data stores, or other network or computing architectures in some cases.

Among other operations, the computing device 102 can be configured to generate (e.g., via the document generator device 106a) a physical document having a unique identifier embedded in or formed on a surface of the document and further interface with or control at least one of the peripheral devices 108 to track, record, and manage various events associated with the document over its entire life cycle. To perform such positive control operations in connection with a physical document as described in examples herein, the computing device 102 can include at least one processing and memory system. In the example depicted in FIG. 1, the computing device 102 includes at least one processor 112 and at least one memory 114, both of which are communicatively coupled, operatively coupled, or both, to a local interface 116. The memory 114 includes a data store 118, a document content detection module 120, a document generator module 122, a document tracker module 124, and a communications stack 126 in the example shown. The computing device 102 can also include other components that are not illustrated in FIG. 1. For example, document content detection, generation, and tracking modules can be focused on removeable media instead of paper documents.

The processor 112 can be embodied as or include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 112 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 114 can be embodied as one or more memory devices and can store data and software or executable-code components executable by the processor 112. For example, the memory 114 can store executable-code components associated with the document content detection module 120, the document generator module 122, the document tracker module 124, and the communications stack 126 for execution by the processor 112. The memory 114 can also store data such as the data described below that can be stored in the data store 118, among other data.

In one example, the memory 114 can store a database (e.g., a list, table, log, record, index) that includes various types of digital documents (e.g., digitally executed contracts, trade secrets) and content to be formed on physical documents or removeable media devices that each have a unique identifier as described in examples herein. In another example, the memory 114 can store a database (e.g., a list, table, log, record, index) that includes various unique identifiers of corresponding physical documents or removeable media devices generated and tracked as described in examples herein, as well as recorded events associated with such documents or devices and/or their respective unique identifiers. In another example, the memory 114 can store a database (e.g., a list, table, log, record, index) that includes defined user-document rights and privileges of certain users in connection with using various physical documents or removeable media devices and/or their respective unique identifiers. In another example, the memory 114 can store a database (e.g., a list, table, log, record, index) that includes defined actions or operations that are to be performed in connection with individual physical documents or removeable media devices based on a detection, use, or attempted use of such documents or devices.

The memory 114 can store other executable-code components for execution by the processor 112. For example, an operating system can be stored in the memory 114 for execution by the processor 112. Where any component discussed herein is implemented in the form of software, any one of a number of programming languages can be employed such as, for example, C, C++, C #, Objective C, JAVA®, JAVASCRIPT®, Perl, PHP, VISUAL BASIC®, PYTHON®, RUBY, FLASH®, or other programming languages.

As discussed above, the memory 114 can store software for execution by the processor 112. In this respect, the terms “executable” or “for execution” refer to software forms that can ultimately be run or executed by the processor 112, whether in source, object, machine, or other form. Examples of executable programs include, for instance, a compiled program that can be translated into a machine code format and loaded into a random access portion of the memory 114 and executed by the processor 112, source code that can be expressed in an object code format and loaded into a random access portion of the memory 114 and executed by the processor 112, source code that can be interpreted by another executable program to generate instructions in a random access portion of the memory 114 and executed by the processor 112, or other executable programs or code.

The local interface 116 can be embodied as a data bus with an accompanying address/control bus or other addressing, control, and/or command lines. In part, the local interface 116 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 118 can include data for the computing device 102 such as, for instance, one or more unique identifiers for the computing device 102, digital certificates, encryption keys, session keys and session parameters for communications, and other data for reference and processing. The data store 118 can also store computer-readable instructions for execution by the computing device 102 via the processor 112, including instructions for the document content detection module 120, the document generator module 122, the document tracker module 124, and the communications stack 126.

In some cases, the data store 118 can also store any or all of the aforementioned databases that can be stored in the memory 114. For example, the data store 118 can store a database (e.g., a list, table, log, record, index) that includes various types of digital documents (e.g., digitally executed contracts, trade secrets) and content to be formed on physical documents or removeable media devices that each have a unique identifier as described in examples herein. In another example, the data store 118 can store a database (e.g., a list, table, log, record, index) that includes various unique identifiers of corresponding physical documents or removeable media devices generated and tracked as described in examples herein, as well as recorded events associated with such documents or devices and/or their respective unique identifiers. In another example, the data store 118 can store a database (e.g., a list, table, log, record, index) that includes defined user-document rights and privileges of certain users in connection with using various physical documents or removeable media devices and/or their respective unique identifiers. In another example, the data store 118 can store a database (e.g., a list, table, log, record, index) that includes defined actions or operations that are to be performed in connection with individual physical documents or removeable media devices based on a detection, use, or attempted use of such documents or devices.

The document content detection module 120 can be embodied as one or more software applications or services executing on the computing device 102. The document content detection module 120 can be executed by the processor 112 to determine a digital document is of a defined type or includes content of a defined type that is to be formed (e.g., printed) on a physical document having a unique identifier that is embedded in or positioned on a surface of the physical document as described in examples herein. For instance, the document content detection module 120 can be executed by the processor 112 to monitor activity on certain applications executing on at least one of the computing device 102 or any of the remote computing devices 104 to detect such digital documents or content of a defined type that is to be formed on a physical document as described herein. In one example, the document content detection module 120 can monitor activity on such applications and devices to detect the creation of an electronic contract, agreement, or other electronic document that becomes a legally binding document once all parties involved have executed the electronic document by way of electronic signatures. In some cases, the document content detection module 120 can detect such a digital document or content in real-time or near-real-time when the digital document or content is generated or when signatories sign the digital document using electronic signatures.

In another example, the document content detection module 120 can monitor activity on certain applications executing on any or all of the computing device 102 or the remote computing devices 104 to detect and intercept any calls or instructions to an analog printing device (e.g., the printer device 108a) to print an analog version (e.g., physical version, printed version) of a digital document or content of a defined type that is to be formed on a physical document having a unique identifier as described in examples herein. In another example, the document content detection module 120 can be executed by the processor 112 to search any memory or database of any or all of the computing device 102 or the remote computing devices 104 to locate digital documents or content of a defined type that is to be formed on a physical document having a unique identifier as described in examples herein.

In other examples, the document content detection module 120 can be focused on removeable media devices instead of physical documents. For instance, the document content detection module 120 can be executed by the processor 112 to perform its operations in connection with removeable media devices in the same or similar manner as described above for physical documents.

The document generator module 122 can be embodied as one or more software applications or services executing on the computing device 102. The document generator module 122 can be executed by the processor 112 to generate a physical document with a unique identifier based on a digital document or content of a defined type that is to be formed on such a physical document as described in examples herein. In one example, the document generator module 122 can be executed by the processor 112 to control and operate the document generator device 106a to generate such a physical document with a unique identifier and content of a digital document. For example, the document generator module 122 can be executed by the processor 112 to generate and provide instructions to the document generator device 106a that when executed cause the document generator device 106a to form a physical document (e.g., a sheet of paper) such that it includes content of a certain digital document and a unique identifier embedded in or formed on the physical document as described in examples herein.

In one example, the document generator device 106a can be configured to print content of a digital document on a sheet of material (e.g., a sheet of paper) using an ink configured for printing on such a sheet of material. The document generator device 106a can be further configured in this example to embed a unique identifier in the sheet of material. For instance, the document generator module 122 can operate the document generator device 106a to print content of a digital document on a sheet of material (e.g., a sheet of paper) using an ink configured for printing on the sheet of material. In this example, the document generator module 122 can further operate the document generator device 106a to embed a unique identifier in the sheet of material. For instance, the document generator module 122 can operate the document generator device 106a to embed in the sheet of material at least one of a watermark identifier, a unique signature identifier, a security signature identifier, an encryption identifier, a logo identifier, a 2D or 3D structure or pattern, a 2D or 3D barcode or quick response (QR) code, a physical property identifier, a chemical identifier, an electrical identifier, an electromagnetic identifier, an optical identifier, a quantum-based identifier (e.g., a quantum dots-based identifier), or another unique identifier.

In another example, the document generator device 106a can be configured to embed a unique identifier in an ink that is configured for printing by the document generator device 106a on a sheet of material (e.g., a sheet of paper). For instance, the document generator device 106a can be further configured to print content of a digital document on a sheet of material using such an ink that includes a unique identifier. In this example, the document generator module 122 can operate the document generator device 106a to embed a unique identifier in an ink configured for printing by the document generator device 106a on a sheet of material (e.g., a sheet of paper). In this example, the document generator module 122 can further operate the document generator device 106a to print content of a digital document on the sheet of material using the ink that includes the unique identifier.

In other examples, the document generator module 122 can be focused on removeable media devices instead of physical documents. For instance, the document generator module 122 can be executed by the processor 112 to perform its operations in connection with removeable media devices in the same or similar manner as described above for physical documents.

The document tracker module 124 can be embodied as one or more software applications or services executing on the computing device 102. The document tracker module 124 can be executed by the processor 112 to track a physical document described herein based on document detection data obtained from at least one of the peripheral devices 108 that detects the document, content thereof, and/or a unique identifier of the document at any time over a life cycle of the document. In various examples, the document detection data can be at least indicative of a status of the physical document at a time of detection by any of the peripheral devices 108. For example, the document detection data provided by one or more of the peripheral devices 108 can include, but is not limited to, detection data (e.g., indicative of a detection of at least one of the physical document, the content, or the unique identifier), location data (e.g., indicative of a physical location of a peripheral device 108 that detects at least one of the physical document, the content, or the unique identifier), possession data (e.g., indicative of an entity such as a person in possession of the physical document at the time of detection), and activity data (e.g., indicative of an action or an operation performed or attempted to be performed on or based on at least one of the physical document, the content, or the unique identifier). In various examples, the document tracker module 124 can be executed by the processor to perform one or more operations based on the above-described document detection data obtained from at least one of the peripheral devices 108.

In one example, the document tracker module 124 can be executed by the processor 112 to record at least part of the aforementioned document detection data in at least one of a database (e.g., a list, table, log, record, index), a memory device (e.g., the memory 114, the data store 118), a distributed ledger, or a blockchain. The document tracker module 124 can record various life cycle events associated with a physical document generated by the document generator module 122 (e.g., via the document generator device 106a or the removeable media generating device 106b) as described in examples herein. For instance, the document tracker module 124 can record one or more printing or attempted printing events detected by way of the printer device 108a, one or more copying or attempted copying events detected by way of the copier device 108b, one or more scanning or attempted scanning events detected by way of the scanner device 108c, one or more faxing or attempted faxing events detected by way of the fax machine device 108d, one or more moving or attempted moving events (e.g., movement of a physical document entering, within, or exiting a facility) detected or captured as images or video by way of the sensor device 108e, applying a label on a piece of removeable media by way of the removeable media labeler device 108f, and one or more shredding or attempted shredding events (e.g., destruction events) detected by way of the shredder device 108g, among other life cycle events associated with a physical document generated as described in examples herein. These life cycle events and others can be provided or described in the document detection data obtained from at least one of the peripheral devices 108 over the life of a physical document that can be generated as described in examples herein. The document detection data can be used by the computing device 102 or the remote computing devices 104 in some cases to perform additional operations such as auditing, periodic back-ups, aggregation of multiple databases that include document detection data for various physical documents and/or removeable media devices.

In another example, the document tracker module 124 can be executed by the processor 112 to generate and provide a notifier to one or more of the remote computing devices 104 or another remote computing device based on obtaining the aforementioned document detection data from at least one of the peripheral devices 108 or another peripheral device. In this example, each of the remote computing devices 104 can be associated with an owner of at least one of a digital document, a physical document generated by the document generator module 122 (e.g., via the document generator device 106a or the removeable media generator device 106b) based on the digital document, content of at least one of the digital document or the physical document, or a unique identifier embedded in or formed on the physical document. In this example, the document tracker module 124 can generate and provide a notifier that includes data indicative of a detection of at least one of the physical document, the content, or the unique identifier, data indicative of a physical location of the detecting peripheral device 108, data indicative of an entity (e.g., an individual) in possession of the physical document at the time of detection, and/or data indicative an action or an operation performed or attempted to be performed on or based on at least one of the physical document, the content, or the unique identifier, among possibly other data.

In another example, the document tracker module 124 can be executed by the processor 112 to determine that an entity (e.g., an individual, user) in possession of a physical document generated by the document generator module 122 (e.g., via the document generator device 106a) as described herein has one or more defined user-document privileges associated with at least one of the physical document, content of the physical document, or a unique identifier embedded in or formed on the physical document. For instance, to achieve such a determination, the document tracker module 124 can compare the entity's user credentials (e.g., user identification, username, user password) that can be obtained from at least one of the peripheral devices 108 against a database (e.g., a list, table) of user credentials that correspond to users having such one or more defined user-document privileges. For example, the document tracker module 124 can perform a query search of such a database using the entity's user credentials.

In one example, the aforementioned one or more defined user-document privileges can grant certain users with certain rights and permissions related to possessing or controlling a physical document and/or performing actions or operations on or based on the physical document or removeable media, its content, and/or its unique identifier. For instance, the one or more defined user-document privileges can grant certain users with certain rights and permissions related to physically possessing or controlling a physical document and/or using at least one of the computing device 102, any of the remote computing devices 104, or any of the peripheral devices 108 to perform one or more actions or operations on or based on the physical document, its content, and/or its unique identifier. The document tracker module 124 can enforce such defined user-document privileges using any or all of the peripheral devices 108 as described in various examples herein.

In one example, based on determining an entity in possession of a physical document generated by the document generator module 122 as described herein (e.g., via the document generator device 106a) has been granted the aforementioned defined user-document privileges, the document tracker module 124 can be executed by the processor 112 to control any or all of the peripheral devices 108 to perform one or more operations associated with at least one of the physical document, its content, or its unique identifier. For instance, the document tracker module 124 can control the printer device 108a to generate a printed copy of the physical document (e.g., a printed copy of an image of the physical document) or a digital document on which the physical document is based. In another example, the document tracker module 124 can control the copier device 108b to generate a photocopy of the physical document on, for instance, a sheet of paper. In another example, the document tracker module 124 can control the scanner device 108c to generate, transmit, and/or render a scanned image (e.g., a digital image) of the physical document. In another example, the document tracker module 124 can control the fax machine device 108d to create, transmit, and/or render a fax image (e.g., a fixed graphic image) of the physical document. In another example, the document tracker module 124 can control the sensor device 108e and, for instance, a door of a facility to allow physical transport of the physical document into, within, or out of the facility. In another example, the document tracker module 124 can control the removeable media labeler device 108f to affix a label onto a piece of removeable media. In another example, the document tracker module 124 can control the shredder device 108g to shred (e.g., destruct) and thereby decommission at least a portion of the physical document or its unique identifier.

In another example, based on determining an entity in possession of a physical document generated by the document generator module 122 as described herein (e.g., via the document generator device 106a) has not been granted the aforementioned defined user-document privileges, the document tracker module 124 can be executed by the processor 112 to control any or all of the peripheral devices 108 to prevent such device(s) from performing one or more operations associated with at least one of the physical document, its content, or its unique identifier. For instance, the document tracker module 124 can control the printer device 108a to prevent the printer device 108a from generating a printed copy of the physical document (e.g., a printed copy of an image of the physical document) or a digital document on which the physical document is based. In another example, the document tracker module 124 can control the copier device 108b to prevent the copier device 108b from generating a photocopy of the physical document on, for instance, a sheet of paper. In another example, the document tracker module 124 can control the scanner device 108c to prevent the scanner device 108c from generating, transmitting, and rendering a scanned image (e.g., a digital image) of the physical document. In another example, the document tracker module 124 can control the fax machine device 108d to prevent the fax machine device 108d from creating, transmitting, and rendering a fax image (e.g., a fixed graphic image) of the physical document. In another example, the document tracker module 124 can control the sensor device 108e and, for instance, a door of a facility to prevent the door from opening and thereby prevent physical transport of the physical document into, within, or out of the facility. In another example, the document tracker module 124 can control the shredder device 108g to prevent the shredder device 108g from shredding (e.g., destructing) and thereby decommissioning at least a portion of the physical document or its unique identifier.

In other examples, the document tracker module 124 can be focused on removeable media devices instead of physical documents. For instance, the document tracker module 124 can be executed by the processor 112 to perform its operations in connection with removeable media devices in the same or similar manner as described above for physical documents.

The communications stack 126 can include software and hardware layers to implement data communications such as, for instance, Bluetooth®, Bluetooth® Low Energy (BLE), WiFi®, cellular data communications interfaces, or a combination thereof. Thus, the communications stack 126 can be relied upon by the computing device 102 to establish cellular, Bluetooth®, WiFi®, and other communications channels with the networks 110 and with at least one of the remote computing devices 104, the document generator device 106a, or any or all of the peripheral devices 108.

The communications stack 126 can include the software and hardware to implement Bluetooth®, BLE, and related networking interfaces, which provide for a variety of different network configurations and flexible networking protocols for short-range, low-power wireless communications. The communications stack 126 can also include the software and hardware to implement WiFi® communication, and cellular communication, which also offers a variety of different network configurations and flexible networking protocols for mid-range, long-range, wireless, and cellular communications. The communications stack 126 can also incorporate the software and hardware to implement other communications interfaces, such as X10®, ZigBee®, Z-Wave®, and others.

The communications stack 126 can be configured to communicate various data or information amongst the computing device 102, the remote computing devices 104, the document generator device 106a, the removeable media generator device 106b, and the peripheral devices 108. Examples of such data or information can include, but is not limited to, the aforementioned document detection data that can be provided by one or more of the peripheral devices 108 and any or all of the above-described databases (e.g., lists, tables, logs, records, indexes) that can be stored in one or both of the memory 114 or the data store 118, or other data or information.

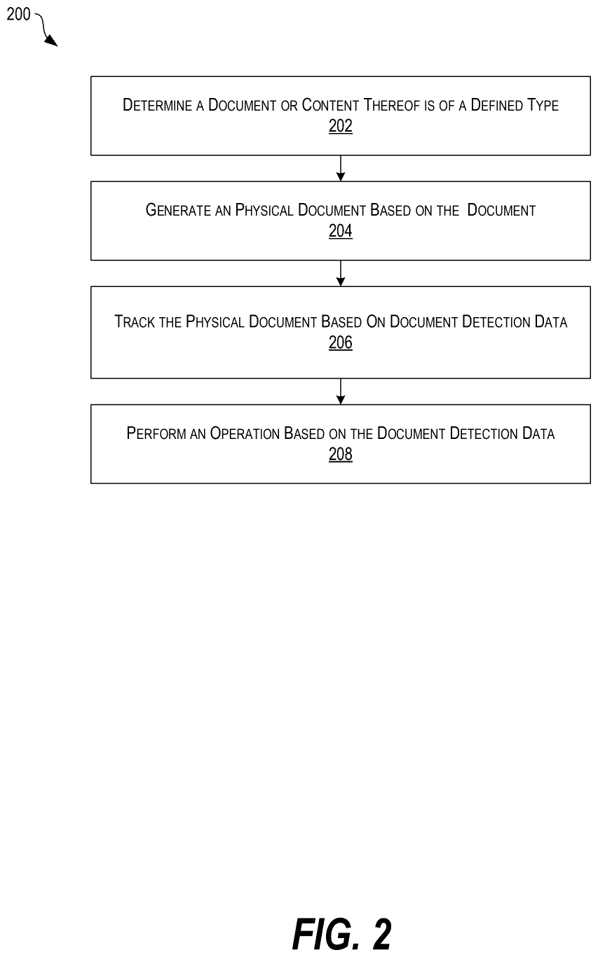

FIG. 2 illustrates a flow diagram of an example computer-implemented method 200 (or “method 200”) according to various aspects and embodiments of the present disclosure. It is understood that the flowchart of FIG. 2 provides merely an example of the many different types of functional arrangements that may be employed to implement the operation of the portion of at least one of the document content detection module 120, the document generator module 122, the document tracker module 124, or the communications stack 126 as described herein. As an alternative, the flowchart of FIG. 2 may be viewed as depicting an example of elements of a method implemented in the environment 100 (FIG. 1) according to one or more embodiments. In one example, the method 200 can be implemented by the computing device 102 (e.g., via the document content detection module 120, the document generator module 122, and the document tracker module 124) using one or more of the remote computing devices 104, the document generator device 106a, and any or all of the peripheral devices 108 as described herein with reference to FIG. 1.

At 202, the method 200 includes determining that a digital document or content thereof is of a defined type. For instance, the computing device 102 can be configured to access (e.g., via the document content detection module 120) memory or storage components of and/or monitor (e.g., via the document generator module 122) activity on at least one of the computing device 102 or any of the remote computing devices 104 or certain applications executing on such devices to detect a digital document or content of a defined type that is to be formed on a physical document as described herein with reference to FIG. 1. As such, any or all of the peripheral devices 108 may be configured selectively based on the contents of the signature detection results.

At 204, the method 200 further includes generating a physical document based on the digital document or its content determined at step 202 to be of the defined type. For instance, the computing device 102 can be configured to control and operate (e.g., via the document generator module 122) the document generator device 106a to generate such a physical document with the content of the digital document and a unique identifier embedded in or formed on a surface of the physical document as described herein with reference to FIG. 1.

At 206, the method 200 further includes tracking the physical document based on document detection data obtained by at least one of the peripheral devices 108 that detects the unique identifier during a life cycle of the physical document. In some examples, the document detection data can be at least indicative of a status of the physical document at a time of detection by at least one of the peripheral devices 108. For instance, the computing device 102 (e.g., via the document tracker module 124) can track life cycle events associated with the physical document based on document detection data obtained from at least one of the peripheral devices 108 that detects the document, content thereof, and/or a unique identifier of the document at any time over a life cycle of the document as described herein with reference to FIG. 1.

At 208, the method 200 further includes performing one or more operations based on the document detection data obtained at step 206. For example, the computing device 102 can be configured to perform any of the operations described herein with reference to FIG. 1 based on such document detection data obtained from at least one of the peripheral devices 108 at step 206. For instance, the computing device 102 can be configured to record (e.g., via the document tracker module 124) at least part of such document detection data, generate and provide a notifier to one or more of the remote computing devices 104, determine that an entity (e.g., an individual, user) in possession of a physical document has one or more defined user-document privileges associated with the physical document or any portion or component thereof, and/or control any or all of the peripheral devices 108 to perform or prevent one or more operations associated with at least one of the physical document, its content, or its unique identifier as described herein with reference to FIG. 1.

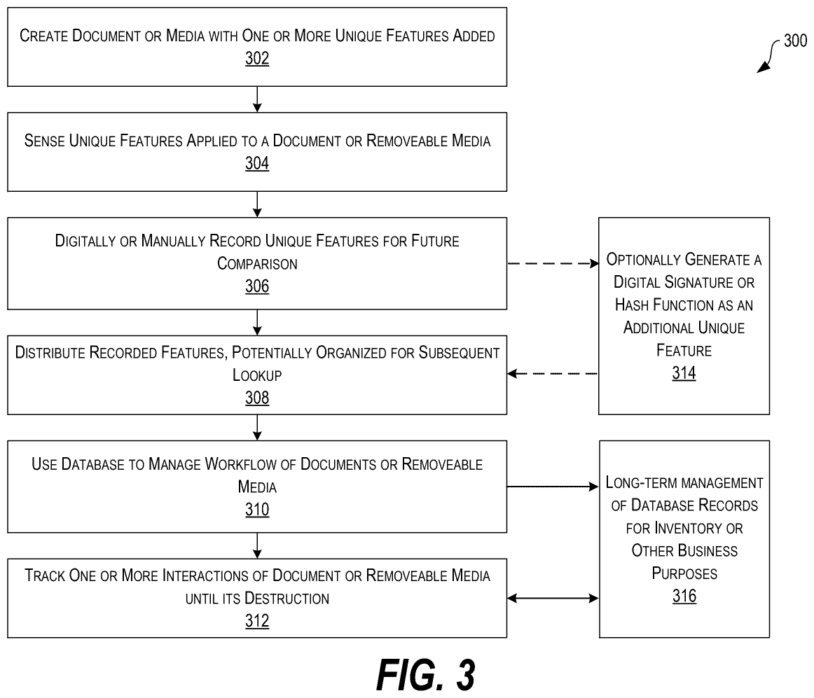

FIG. 3 illustrates a flow diagram of another example computer-implemented method (or “method 300”) to implement an example life cycle of a document or removeable media item according to various aspects and embodiments of the present disclosure. It is understood that the flowchart of FIG. 3 provides merely an example of the many different types of functional arrangements that may be employed to implement the operation of the portion of at least one of the document content detection module 120, the document generator module 122, the document tracker module 124, or the communications stack 126 as described herein. As an alternative, the flowchart of FIG. 3 may be viewed as depicting an example of elements of a method implemented in the environment 100 (FIG. 1) according to one or more embodiments. In one example, the method 300 can be implemented by the computing device 102 (e.g., via the document content detection module 120, the document generator module 122, and the document tracker module 124) using one or more of the remote computing devices 104, the document generator device 106a, and any or all of the peripheral devices 108 as described herein with reference to FIG. 1.

FIG. 3 depicts a flowchart of one example method 300 that can be implemented over a conceptual lifecycle of a document or removeable media device under positive control as described in examples herein. This life cycle begins at 302 of the method 300 as described below.

At 302, the method 300 includes creating a physical document or removeable media device (e.g., via the document generator device 106a or removeable media generating device 106b) with one or more unique identifiers or features added to the document or device. The document or removeable media device may be marked at the time of creation in some cases or ahead of time before data content is added in other cases.

At 304, the method 300 includes sensing the unique identifiers or features applied to the document or device created at 302. For instance, any or all of the peripheral devices 108 discussed previously (e.g., the printer device 108a, the copier device 108b, the scanner device 108c, the fax machine device 108d, the sensor or camera device 108e, the removeable media labeler device 108f, the shredder device 108g, the laminator device 108h, the RFID scanner device 108i, the QR code scanner device 108j, the removeable media reader device 108k) may be used to sense the unique identifiers or features applied to the physical document or removeable media device.

After reading the unique features, which may be optionally communicated to other devices, at 306 of the method 300, the unique features may be recorded (e.g., via the document tracker module 124) in electronic, digital, or physical formats for future comparison. The recorded results of the unique features may be distributed, organized into databases, or otherwise prepared (e.g., via the document tracker module 124) for future lookup at 308 of the method 300. At 314 of the method 300, an optional task for the features is to create additional metadata, such as cryptographic signatures or hash functions, that are used to label that item in a recorded format.

After distributing the recorded features of the document or removeable media, at 310 of the method 300, a database or other manual or digital organization structure may be used (e.g., via the document tracker module 124) to manage the state of a controlled item such as a controlled physical document or removeable media device.

Once under positive control, at 312 of the method 300, interactions such as scanning, duplicating, or destruction using any or all of the peripheral devices 108 discussed previously may be performed (e.g., via the document tracker module 124) sequentially or in tandem, with a record of the action(s) performed to the controlled item being recorded in the database at step 310. In tandem with these interactions with the controlled item, or a plurality of such controlled items, at 316 of the method 300 the results of those interactions for a plurality of controlled items can be managed (e.g., via the document tracker module 124) in a single location and/or by a single computing system (e.g., the computing device 102). Optionally, such a computing system may be used for local or global management, inventory, or surveillance of controlled items.

FIG. 4 illustrates a block diagram of example document or removeable media modifications 400 according to various aspects and embodiments of the present disclosure. The computing device 102 can implement one or more of the document or removeable media modifications 400 on a physical document or removeable media device, respectively, in the environment 100 in many examples. The document or removeable media modifications 400 illustrated in FIG. 4 are representative of example unique identifier application techniques or methods that can be implemented by the computing device 102 to apply one or more unique identifiers to a physical document or removeable media device, respectively. In other examples, the document or removeable media modifications 400 may include a different number or type of unique identifier application methods compared to those shown in FIG. 4. To offer more insight into the mechanisms that may be used to uniquely mark a controlled item (e.g., a document or piece of removeable media device), a description of marking steps is described below with reference to the block diagram illustrated in FIG. 4.

For a given physical document or removeable media device 402 (also “document or device 402”), the computing device 102 (e.g., via the document generator module 122, the document generator device 106a, the removeable media generator device 106b) can apply one or more unique identifier application techniques or methods 404 to the document or device 402 to mark it as described in examples herein. The unique identifier application methods 404 can include the marking (e.g., via the document generator device 106a or the removeable media generating device 106b) in or on of the document or device 402 with a specialized ink 404a (e.g., iridescent, detectable with electro-optical or infra-red means, x-rays), a magnetic ink 404b (e.g., RFID detectable images), quantum dots 404c, a custom label or an anti-tamper material 404d, and a custom stamp 404e, among others. For example, the custom stamp 404e may be embodied as any of the preceding physical identifiers implanted in or affixed to a controlled item, as might be used in authenticating a physical document such as is done by a public notary.

Ink or marking methods in the unique identifier application methods 404 can be implemented by the computing device 102 in a single stage in some cases (e.g., mixing components to create custom inks before applying or on a pixel-by-pixel basis during creation) or in multiple stages in other cases (e.g., a sequential application of different inks or marking methods). Other unique identifier application methods to apply heat curing treatments, chemical processes, or other similar methods may be implemented by the computing device 102 in some examples and still remain within the scope of the present disclosure without loss of generality or intent of the present disclosure. In considering the custom label or anti-tamper material 404d application method, pre-existing documents can be retroactively marked by the computing device 102 with an ink or label or other recognizable feature and entered into a database for subsequent management in some cases (e.g., auditing, periodic back-ups, aggregation of databases).

Referring now to FIG. 1, the memory 114 can store other executable-code components for execution by the processor 112. For example, an operating system can be stored in the memory 114 for execution by the processor 112. Where any component discussed herein is implemented in the form of software, any one of a number of programming languages can be employed such as, for example, C, C++, C #, Objective C, JAVA®, JAVASCRIPT®, Perl, PHP, VISUAL BASIC®, PYTHON®, RUBY, FLASH®, or other programming languages.

As discussed above, the memory 114 can store software for execution by the processor 112. In this respect, the terms “executable” or “for execution” refer to software forms that can ultimately be run or executed by the processor 112, whether in source, object, machine, or other form. Examples of executable programs include, for instance, a compiled program that can be translated into a machine code format and loaded into a random access portion of the memory 114 and executed by the processor 112, source code that can be expressed in an object code format and loaded into a random access portion of the memory 114 and executed by the processor 112, source code that can be interpreted by another executable program to generate instructions in a random access portion of the memory 114 and executed by the processor 112, or other executable programs or code. An executable program can be stored in any portion or component of the memory 114. The memory 114 can be embodied as, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 114 can include both volatile and nonvolatile memory and data storage components. Volatile components are those that do not retain data values upon loss of power. Nonvolatile components are those that retain data upon a loss of power. Thus, the memory 114 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory devices.

Also, the processor 112 may represent multiple processors 112 and/or multiple processor cores and the memory 114 may represent multiple memories 114 that operate in parallel processing circuits, respectively. In such a case, the local interface 116 may be an appropriate network that facilitates communication between any two of the multiple processors 112, between any processor 112 and any of the memories 114, or between any two of the memories 114, etc. The local interface 116 may include additional systems designed to coordinate this communication, including, for example, performing load balancing. The processor 112 may be of electrical or of some other available construction.

Any or all of the document content detection module 120, the document generator module 122, the document tracker module 124, and the communications stack 126 can be embodied, at least in part, through software or program instructions. The program instructions may be embodied in the form of source code that comprises human-readable statements written in a programming language or machine code that comprises numerical instructions recognizable by a suitable execution system such as a processor 112 in a computer system or other system. The machine code may be converted from the source code, etc. If embodied in hardware, each block may represent a circuit or a number of interconnected circuits to implement the specified logical function(s).

Further, any logic or application described herein, including the document content detection module 120, the document generator module 122, the document tracker module 124, and the communications stack 126, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same the computing environment.

As discussed above, the document content detection module 120, the document generator module 122, the document tracker module 124, and the communications stack 126 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIGS. 2 and 3, the flowchart or process diagram shown in each of FIGS. 2 and 3 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 112. The machine code can be converted from the source code. Further, each block can represent, or be connected with, a circuit or a number of interconnected circuits to implement a certain logical function or process step.

Although the flowchart or process diagram shown in each of FIGS. 2 and 3 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the document content detection module 120, the document generator module 122, the document tracker module 124, and the communications stack 126 can be embodied, at least in part, by software or executable-code components and/or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIGS. 2 and 3. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.”

As referred to herein, the terms “include,” “includes,” and “including” are each intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A computing device, comprising:
a memory device to store computer-readable instructions thereon; and
at least one processing device configured through execution of the computer-readable instructions to:
determine a document comprises content of a defined type;
generate a physical document based at least in part on the document, the physical document comprising the content and a unique identifier;
track the physical document based at least in part on document detection data obtained from at least one peripheral device that detects the unique identifier during a life cycle of the physical document, the document detection data being at least indicative of a status of the physical document at a time of detection by the at least one peripheral device; and
perform one or more operations based at least in part on the document detection data.

2. The computing device of claim 1, wherein, to determine the document comprises the content of the defined type, the at least one processing device is further configured through execution of the computer-readable instructions to:
determine the document comprises the content of the defined type during generation or execution of the document.

3. The computing device of claim 1, wherein, to generate the physical document based at least in part on the document, the at least one processing device is further configured through execution of the computer-readable instructions to:
print the content of the document on a sheet of material using an ink or a toner configured for printing on the sheet of material and a printing device configured to print the ink on the sheet of material; and
embed the unique identifier in or on the sheet of material.

4. The computing device of claim 1, wherein, to generate the physical document based at least in part on the document, the at least one processing device is further configured through execution of the computer-readable instructions to:
embed the unique identifier in an ink or a toner configured for printing on a sheet of material; and
print the content of the document on the sheet of material using the ink or the toner and a printing device configured to print the ink or the toner on the sheet of material.

5. The computing device of claim 1, wherein the at least one peripheral device comprises at least one of a printer device, a copier device, a scanner device, a fax machine device, a sensor device, a removeable media labeler device, a shredder device, a laminator device, a radio frequency identification scanner device, a quick response code scanner device, a removeable media reader device, or an intelligent infrastructure device.

6. The computing device of claim 1, wherein the document detection data comprises at least one of:
detection data indicative of a detection of at least one of the physical document, the content, or the unique identifier;
location data indicative of a physical location of the at least one peripheral device;
possession data indicative of an entity in possession of the physical document at the time of detection; or
activity data indicative of an action or an operation performed or attempted to be performed on or based at least in part on at least one of the physical document, the content, or the unique identifier.

7. The computing device of claim 1, wherein, to perform the one or more operations based at least in part on the document detection data, the at least one processing device is further configured through execution of the computer-readable instructions to:
record the document detection data in at least one of a database, a memory device, a distributed ledger, or a blockchain.

8. The computing device of claim 1, wherein, to perform the one or more operations based at least in part on the document detection data, the at least one processing device is further configured through execution of the computer-readable instructions to:
provide a notifier to a remote computing device based at least in part on obtaining the document detection data from the at least one peripheral device, the remote computing device being associated with an owner of at least one of the document, the physical document, the content, or the unique identifier.

9. The computing device of claim 8, wherein the notifier comprises data indicative of at least one of:
a detection of at least one of the physical document, the content, or the unique identifier;
a physical location of the at least one peripheral device;
an entity in possession of the physical document at the time of detection; or
an action or an operation performed or attempted to be performed on or based at least in part on at least one of the physical document, the content, or the unique identifier.

10. The computing device of claim 1, wherein, to perform the one or more operations based at least in part on the document detection data, the at least one processing device is further configured through execution of the computer-readable instructions to:
determine an entity in possession of the physical document has one or more defined user-document privileges associated with at least one of the physical document, the content, or the unique identifier.

11. The computing device of claim 10, wherein, to perform the one or more operations based at least in part on the document detection data, the at least one processing device is further configured through execution of the computer-readable instructions to:
control the at least one peripheral device to perform an operation associated with at least one of the physical document, the content, or the unique identifier based at least in part on the one or more defined user-document privileges.

12. The computing device of claim 10, wherein, to perform the one or more operations based at least in part on the document detection data, the at least one processing device is further configured through execution of the computer-readable instructions to:
control the at least one peripheral device to prevent the at least one peripheral device from performing an operation associated with at least one of the physical document, the content, or the unique identifier based at least in part on the one or more defined user-document privileges.

13. The computing device of claim 1, wherein the unique identifier comprises at least one of a watermark identifier, a signature identifier, a logo identifier, a two-dimensional or three-dimensional barcode, a two-dimensional or three-dimensional quick response code, a physical property identifier, a chemical identifier, an electrical identifier, an electromagnetic identifier, an optical identifier, or a quantum-based identifier.

14. The computing device of claim 1, wherein the physical document comprises at least one of a sheet of material, a film, a sheet of fibers, a sheet of paper, a textile, a sheet of fabric, or a plate.

15. A computer-implemented method for positive control of physical documents, the method comprising:
determining, by at least one processor, a document comprises content of a defined type;
generating, by the at least one processor, a physical document based at least in part on the document, the physical document comprising the content and a unique identifier;
tracking, by the at least one processor, the physical document based at least in part on document detection data obtained from at least one peripheral device that detects the unique identifier during a life cycle of the physical document, the document detection data being at least indicative of a status of the physical document at a time of detection by the at least one peripheral device; and
performing, by the at least one processor, one or more operations based at least in part on the document detection data.

16. The method of claim 15, wherein determining the document comprises the content of the defined type comprises:
determining, by the at least one processor, the document comprises the content of the defined type during generation or execution of the document.

17. The method of claim 15, wherein generating the physical document based at least in part on the document comprises:
printing, by the at least one processor, the content of the document on a sheet of material using an ink or a toner configured for printing on the sheet of material and a printing device configured to print the ink or the toner on the sheet of material; and
embedding, by the at least one processor, the unique identifier in or on the sheet of material.

18. The method of claim 15, wherein generating the physical document based at least in part on the document comprises:
embedding, by the at least one processor, the unique identifier in an ink or a toner configured for printing on a sheet of material; and
printing, by the at least one processor, the content of the document on the sheet of material using the ink or the toner and a printing device configured to print the ink or the toner on the sheet of material.

19. The method of claim 15, wherein the at least one peripheral device comprises at least one of a printer device, a copier device, a scanner device, a fax machine device, a sensor device, a removeable media labeler device, a shredder device, a laminator device, a radio frequency identification scanner device, a quick response code scanner device, a removeable media reader device, or an intelligent infrastructure device.

20. The method of claim 15, wherein the document detection data comprises at least one of:
detection data indicative of a detection of at least one of the physical document, the content, or the unique identifier;
location data indicative of a physical location of the at least one peripheral device;
possession data indicative of an entity in possession of the physical document at the time of detection; or
activity data indicative of an action or an operation performed or attempted to be performed on or based at least in part on at least one of the physical document, the content, or the unique identifier.
